(19) United States
(12) Patent Application Publication
(10) Pub. No.: US 2024/0271507 A1
(43) Pub. Date: Aug. 15, 2024

(54) CARBON DIOXIDE SEQUESTRATION METHOD BASED ON RESERVOIR WETTABILITY OPTIMIZATION DESIGN AND STRATIFIED REGULATION

(71) Applicant: DALIAN UNIVERSITY OF TECHNOLOGY, Dalian (CN)

(72) Inventors: Yongchen SONG, Dalian (CN); Cong CHEN, Dalian (CN); Yingying CUI, Dalian (CN); Jingyue SUN, Dalian (CN); Qianli MA, Dalian (CN); Zherui CHEN, Dalian (CN); Yu LIU, Dalian (CN); Yi ZHANG, Dalian (CN); Yan QIN, Dalian (CN); Lanlan JIANG, Dalian (CN); Mingjun YANG, Dalian (CN); Yuechao ZHAO, Dalian (CN)

(21) Appl. No.: 18/124,184

(22) Filed: Mar. 21, 2023

(30) Foreign Application Priority Data
Feb. 13, 2023 (CN) 202310102230.8

(51) Int. Cl. E21B 41/00; E21B 43/16

(52) U.S. Cl. CPC E21B 41/0064; E21B 43/164; E21B 2200/20

(57) ABSTRACT

A carbon dioxide sequestration method based on reservoir wettability optimization design and layered regulation, which proposes the following four schemes for a carbon dioxide sequestration process: a carbon dioxide sequestration process seepage characteristics simulation scheme, a reservoir wettability optimization design scheme, a reservoir wettability regulation scheme and a carbon dioxide sequestration well layout design scheme. Firstly, a quantitative relation between the contact angle and the carbon dioxide seepage characteristics of a reservoir is obtained by relevant methods, a large scale simulator is used to quantitatively simulate the influence of the contact angle distribution of the reservoir on carbon dioxide sequestration, and layered optimization design and regulation of reservoir wettability are carried out according to the simulation results; and a well layout mode of “using one well for multiple purposes—using two wells in conjunction—adopting a network layout” is used to improve the flexibility of well layout.

### TECHNICAL FIELD

The present invention belongs to the technical field of carbon dioxide sequestration, and relates to a carbon dioxide sequestration method based on reservoir wettability optimization design and stratified regulation.

### BACKGROUND

### (1) Carbon Dioxide Sequestration Technology:

In recent years, due to the global dependence on fossil fuels, the greenhouse effect is seriously threatening the global environment, the carbon dioxide sequestration technology, especially the geological sequestration technology, has been paid more and more attention and research.

The geological sequestration technology refers to the use of geological structures to store carbon dioxide. Major sequestration sites include deep saline aquifer in sedimentary basins, abandoned coal seam, and oil and natural gas fields, among which oil and natural gas fields includes abandoned oil and natural gas fields and oil and natural gas fields, i.e., the CO2-EOR technology (carbon dioxide enhanced oil recovery technology). In strata, fluid movement in a high permeability layer is limited by the surrounding environment, especially a low permeability layer above, so a fluid stays in situ for a long time. In such a closed structure, high permeability rock is called a reservoir, and low permeability rock is called a cover. Carbon dioxide geological sequestration means that carbon dioxide is artificially injected into the reservoir of the closed structure by drilling holes to be isolated from the atmosphere for a long time. Once injected, as carbon dioxide is less dense than the surrounding environment, a carbon dioxide plume will be raised by buoyancy, and when encountering the cover, the carbon dioxide will be diffused laterally until a gap is encountered. If a fault appears near an injection zone, the carbon dioxide may migrate to the ground surface along the fault and leak into the atmosphere, posing a potential hazard to the life in the surrounding area. Therefore, it is an important research topic to improve the capacity of carbon dioxide sequestration and ensure the sequestration safety at the same time.

### (2) Carbon Dioxide Seepage Characteristics Simulation Method:

After carbon dioxide is injected into the reservoir, the interaction among carbon dioxide, reservoir fluid and rock is a complex process which includes seepage flow, mechanical response and chemical reaction of multi-phase fluids. To research this process quantitatively, the simulation and calculation of the two-phase flow of carbon dioxide and reservoir fluid can be conducted. In a simulation process, the reservoir and the cover of the rock in the strata are usually considered separately, and only force change is considered for the cover. Since reservoir rock is mostly sandstone and contains many pores, which can be treated as a porous medium, the simulation process can be understood as a problem of two-phase flow in porous medium.

The wettability of the rock affects the migration law, trapping capability, sequestration capacity and leakage possibility of carbon dioxide in a deep reservoir. Generally, the wettability of a solid surface is evaluated by a contact angle. The contact angle ranges from 0° to 180°, and generally refers to the included angle between the solid interface of the rock and a fluid with a relatively high density. The larger the contact angle is, the poorer the reservoir wettability is, and the higher the capacity of carbon dioxide sequestration is. The contact angle is an important factor in a carbon dioxide seepage characteristics simulation process. However, no direct quantitative relation between the contact angle and carbon dioxide seepage characteristics simulation has been formed yet.

### (3) Rock Wettability Regulation Method:

Rock wettability is a basic characteristic parameter of the physical properties of the reservoir. Currently, the methods for changing rock wettability can be divided into three categories: physical methods, chemical methods and microbial methods. Chemical methods are usually to add chemical agents in the injected water to regulate the wettability of the rock surface of the reservoir, so as to change the wettability direction of rock pore surface, which can significantly improve the sequestration rate. Wetting-transition agents used for regulating rock wettability by chemical methods include: inorganic salts, surfactants, new films, etc.

### SUMMARY

The purpose of the present invention is to quantitatively research the influence of the change of reservoir wettability, i.e., the change of the contact angle, on carbon dioxide sequestration, conduct optimization design to reservoir wettability on this basis, and then conduct layered regulation to effectively increase the capacity of carbon dioxide sequestration, improve the injectability of carbon dioxide, and reduce the risk of carbon dioxide leakage.

To achieve the above purpose, the present invention adopts the following technical solution:

A carbon dioxide sequestration method based on reservoir wettability optimization design and layered regulation, which proposes the following four schemes for a carbon dioxide sequestration process: a carbon dioxide sequestration process seepage characteristics simulation scheme, a reservoir wettability optimization design scheme, a reservoir wettability regulation scheme and a carbon dioxide sequestration well layout design scheme. The details of the four schemes are as follows:

### Step 1, Carbon Dioxide Sequestration Process Seepage Characteristics Simulation Scheme:

1.1) Detecting strata used for carbon dioxide sequestration and sampling a rock core to obtain a height H and an initial contact angle α₀ of a reservoir (4) in the strata. A stratum is divided into the reservoir (4) and a cover (3), both of which are rock, but the reservoir (4) has relatively large voids and contains much liquid saline water, oil or gas. Rock wettability regulation refers to the rock wettability regulation of the reservoir (4).

1.2) Improving a relative permeability model and a capillary pressure model used for numerical calculation in a large scale simulator of carbon dioxide geological sequestration at present as follows: obtaining a relation L=f₁(α) between liquid film thickness on rock surface and contact angle by a molecular simulation method, deducing a quantitative relation Kᵣ=f₃(S_{wr})=f₃(α) between a relative permeability Kᵣ and the contact angle α as well as a quantization relation P_{c}=f₄ (S_{wr})=f₄(α) between a capillary pressure P_{c} and the contact angle α in combination with a reservoir liquid residual saturation S_{wr}=f₂ (L)=f₂(α), using the quantization relations as new relative permeability model and capillary pressure model to conduct simulation and calculation and quantitatively research the influence of contact angle on carbon dioxide seepage characteristics.

1.3) Using the improved large scale simulator of carbon dioxide geological sequestration to conduct numerical calculation again, and conducting simulation for multiple times respectively in combination with a reservoir wettability optimization design scheme of step 2 to obtain the simulation results of carbon dioxide seepage characteristics in different contact angle conditions.

### Step 2, Reservoir Wettability Optimization Design Scheme:

To increase the capacity of carbon dioxide sequestration and reduce the risk of carbon dioxide leakage, according to the carbon dioxide sequestration process seepage characteristics simulation scheme, using the large scale simulator improved in step 1.2) to simulate the carbon dioxide seepage characteristics of the reservoir in different contact angle conditions, and conducting reservoir wettability optimization design according to the simulation results; the design scheme comprises:

### Design Scheme \textcircled{1}: Conducting Uniform Design to the Contact Angle of the Reservoir

Designing the contact angle of the reservoir into a uniform and fixed value α>α₀, and setting different value ranges of a in the large scale simulator for simulation respectively. Selecting an optimal value range of the contact angle α of the reservoir according to the simulation results (using the optimal value range as a target contact angle value range), and implementing a reservoir wettability regulation scheme according to the value range of a and the value of H.

### Design Scheme \textcircled{2}: Regulating the Contact Angle of the Reservoir by Two Layers

Designing a two-layer structure for the reservoir (4) below the cover (3), comprising a first regulation layer (41) and a second regulation layer (42) below. Designing a relatively small contact angle β₁<α₀ below the cover (3), i.e., in the first regulation layer (41), and designing the height thereof into H₁, wherein H₁<H, so that the wettability of the first regulation layer (41) is enhanced to prevent the diffusion of carbon dioxide hitherward, thus reducing the risk of carbon dioxide leakage near the cover (3) and enhancing the sealing property of the cover (3); designing a relatively large contact angle β₂>α₀ below the first regulation layer (41), i.e., in the second regulation layer (42), and designing the height thereof into H-H₁, so that the wettability of the second regulation layer (42) is reduced and the second regulation layer (42) is used as a carbon dioxide sequestration layer; setting different value ranges of β₁ and β₂ in the large scale simulator, matching with different values of H₁ for simulation respectively, selecting a set of optimal matches between the value ranges of β₁ and β₂ and the values of H₁ according to the simulation results (using the optimal value ranges as target contact angle value ranges), and implementing a reservoir wettability regulation scheme according to the value ranges of β₁ and β₂ and the values of H₁.

Obtaining the heights and the target contact angle value ranges of the regulation layers through the above design scheme \textcircled{1} and design scheme \textcircled{2}.

Further, in the design scheme \textcircled{1}, a criterion for judging an optimal match between the value range of the contact angle and the value of the height of the regulation layer is that, within a certain injection time and sequestration time, the higher the capacity of carbon dioxide sequestration and the lower the quantity of leakage are, the better the match between the contact angle and the height of a regulation layer is.

Further, in the design scheme \textcircled{2}, a criterion for judging an optimal match between the value ranges of β₁ and β₂ and the value of H₁ is that, within a certain injection time and sequestration time, the higher the capacity of carbon dioxide sequestration and the lower the quantity of leakage are, the better the match between the contact angles and the height of a regulation layer is.

Further, when more than one high density fluids are present in the reservoir, e.g., water and oil are present in an oil field, the contact angle of a main displacing fluid in the reservoir is regulated uniformly in the design scheme \textcircled{1}.

Further, when more than one high density fluids are present in the reservoir, e.g., water and oil are present in an oil field, in the design scheme \textcircled{2}, two regulation schemes can be designed for the first regulation layer (41), i.e., the contact angles of the two fluids are regulated respectively, and only the contact angle of the main displacing fluid is regulated in the second regulation layer (42). The main displacing fluid can be known according to the research object, for example, in an oil field, the main displacing fluid is oil, and in a deep saline aquifer in a basin, the main displacing fluid is saline water.

### Step 3, Reservoir Wettability Regulation Scheme:

Selecting an appropriate wetting-transition agent according to the target contact angle value ranges set in the reservoir wettability optimization design scheme of step 2, and adopting different regulation schemes according to the different design schemes in step 2, which are specifically as follows:
Regulation scheme \textcircled{1}: to achieve the uniform value range of the contact angle α set in the design scheme \textcircled{1}, selecting a wetting-transition agent of corresponding type and concentration (so that the wettability of rock can be effectively regulated by the wetting-transition agent) to regulate the contact angle of the reservoir (4) to the selected optimal value range of α;
Regulation scheme \textcircled{2}: to achieve the value range of the contact angle β₁ designed for the first regulation layer (41) and the value range of the contact angle β² designed for the second regulation layer (42) in the design scheme \textcircled{2}, selecting a wetting-transition agent of corresponding type and concentration respectively to regulate the contact angles of the first regulation layer (41) and the second regulation layer (42) to the selected optimal value ranges of β₁ and β₂;
Injecting the selected wetting-transition agent respectively into the regulation layers with the set heights according to the design schemes and the regulation schemes, and regulating the wettability of the regulation layers with different heights accordingly.

Further, to prevent carbon dioxide leakage, injecting carbon dioxide at the bottom of the reservoir (4) only.

Further, the wetting-transition agent injection modes for the design scheme (and the regulation scheme \textcircled{1} include:
Injection mode \textcircled{1}: when carbon dioxide is sequestrated, a corresponding wetting-transition agent is dissolved in the carbon dioxide to be sequestrated and injected into the reservoir (4) together;
Injection mode \textcircled{2}: a corresponding wetting-transition agent is dissolved in water and injected into the reservoir (4) in advance, and after a period of time, carbon dioxide is injected into the reservoir for sequestration.

Further, the wetting-transition agent injection modes for the design scheme @ and the regulation scheme \textcircled{2} include:
Injection mode \textcircled{1}: when carbon dioxide is sequestrated, a corresponding wetting-transition agent is dissolved in water and injected into the first regulation layer (41), and the corresponding wetting-transition agent is dissolved in the carbon dioxide to be sequestrated and injected into the second regulation layer (42) together;
Injection mode \textcircled{2}: a corresponding wetting-transition agent is dissolved in water and injected into corresponding regulation layers in advance, and after a period of time, carbon dioxide is injected into the second regulation layer (42) for sequestration.

Further, a carbon dioxide tracer can also be injected simultaneously during carbon dioxide and wetting-transition agent injection to track the movement status of carbon dioxide in real time.

In addition, in the present invention, after the reservoir wettability regulation scheme is implemented, a carbon dioxide sequestration well layout scheme can also be designed, which uses a well layout mode of “using one well for multiple purposes—using two wells in conjunction—adopting a network layout”:
Using one well for multiple purposes means that one well can be used as either an injection well (1) or a producing well (2), and is provided with a carbon dioxide monitoring point (5) which can monitor the concentration of carbon dioxide in real time;
Using two wells in conjunction means that well 1 and well 2 are used in conjunction in a carbon dioxide sequestration process, well 1 is used as an injection well (1) to inject carbon dioxide into the reservoir, and well 2 is used as a producing well (2) to extract the original fluid in the reservoir while the carbon dioxide is injected, so as to reduce the injection pressure drag of the carbon dioxide and improve the injectability of the carbon dioxide. After carbon dioxide is injected by well 1 for reaction, an appropriate amount of water can be injected to push the carbon dioxide to move forward, and then carbon dioxide injection is continued for sequestration. The concentration of ambient carbon dioxide is monitored by well 2 in real time while the original fluid is extracted;
Adopting a network layout means that: well 1 and well 2 are arranged first, well 1 is used as an injection well (1), and well 2 is used as a producing well (2); when the concentration of carbon dioxide monitored by well 2 reach a certain value, a certain amount of carbon dioxide is sequestrated in the reservoir between the two wells, and well 1 can be stopped; well 2 is used as an injection well (1) for injection, and well 3 is used as a producing well (2) for extraction and monitoring; by analogy, after sequestration is completed by well 2 and well 3, well 4, well 5 and well 6 can be further arranged for sequestration; and the distance and azimuth angles between the wells can be arranged as required to form a network layout.

Compared with the prior art, the present invention has the following beneficial effects:
(1) On the basis of obtaining the quantitative relation between the contact angle and the carbon dioxide seepage characteristics of the reservoir, the carbon dioxide sequestration process seepage characteristics are simulated, which provides a scientific and effective planning and implementation scheme for reservoir wettability optimization design, and effectively improves the effect of reservoir wettability regulation;
(2) Layered regulation of the reservoir wettability is conducted. The first regulation layer is provided below the cover to reduce the contact angle of liquid, improve the reservoir wettability, effectively reduce the risk of carbon dioxide leakage, and improve the sequestration security. The second regulation layer is provided below the first regulation layer to increase the contact angle of liquid, reduce the reservoir wettability, and act as a carbon dioxide sequestration layer to improve the sequestration capacity;
(3) In the well layout scheme, the scheme of “using two wells in conjunction” is adopted. When carbon dioxide is injected into well 1, the original fluid is extracted by well 2 at the same time. After carbon dioxide is injected by well 1 for a period of time, an appropriate amount of water is injected to push the carbon dioxide to move forward, which can effectively reduce the injection pressure drag of the carbon dioxide and improve the injectability of the carbon dioxide;
(4) In the well layout scheme, a carbon dioxide monitoring point is provided in each well to monitor the concentration of carbon dioxide in the reservoir in real time and control the injection time in time;
(5) In the well layout scheme, the scheme of “using one well for multiple purposes and adopting a network layout” is used to improve the flexibility of well layout.

### DESCRIPTION OF DRAWINGS

FIG. 1 is a content flow chart of a carbon dioxide sequestration method based on reservoir wettability optimization design and layered regulation of an embodiment;

FIG. 2 is a reservoir wettability regulation diagram based on a reservoir wettability optimization design scheme \textcircled{2} of an embodiment;

FIG. 3 is a design drawing of a carbon dioxide sequestration well layout of an embodiment;

FIG. 4 is a schematic diagram of a working fluid injection process based on a reservoir wettability optimization design scheme \textcircled{2} of an embodiment;

FIG. 5 is a reservoir wettability regulation diagram based on a reservoir wettability optimization design scheme \textcircled{1};

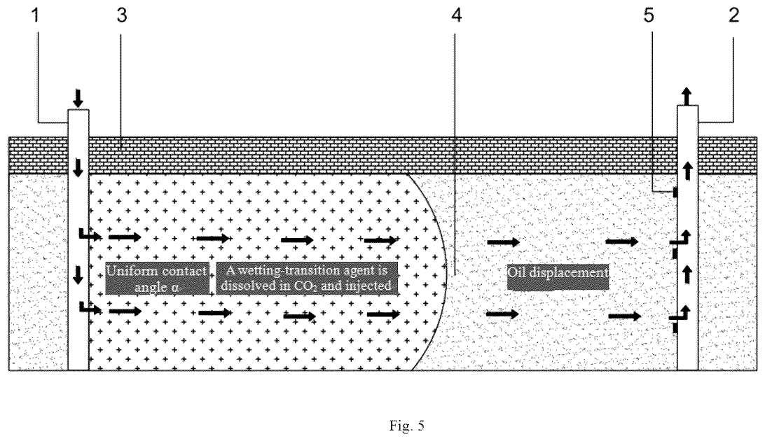

In the figures: 1 injection well; 2 producing well; 3 cover; 4 reservoir; 5 carbon dioxide monitoring point; 41 first regulation layer; 42 second regulation layer.

### DETAILED DESCRIPTION

To make the purpose, the technical solution and the advantages of the present invention more clear, the present invention will be further explained and described below in combination with the drawings and the embodiment. The specific embodiment described herein is only used for explaining the present invention, not used for limiting the present invention.

The embodiment discloses a carbon dioxide sequestration method based on reservoir wettability optimization design and layered regulation, which is illustrated by taking the enhanced oil recovery technology of carbon dioxide sequestration in an oil field as an example.

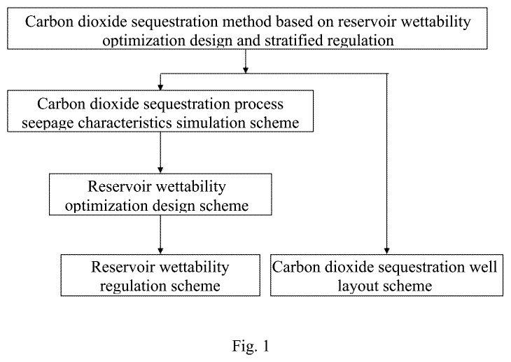

As shown in FIG. 1, the method proposes the following four schemes for a carbon dioxide sequestration process: a carbon dioxide sequestration process seepage characteristics simulation scheme, a reservoir wettability optimization design scheme, a reservoir wettability regulation scheme and a carbon dioxide sequestration well layout design scheme, wherein the first three are progressive, reservoir wettability optimization design will be conducted according to the carbon dioxide sequestration process seepage characteristics simulation results, and reservoir wettability regulation will be conducted according to the value range of the contact angle designed in the reservoir wettability optimization design scheme.

### Step 1, Carbon Dioxide Sequestration Process Seepage Characteristics Simulation Scheme:

1.1) Detecting strata used for carbon dioxide sequestration and sampling a rock core to obtain a height of 200 m, an oil initial contact angle of 20° and a water initial contact angle of 115° of a reservoir (4) in the strata.

1.2) Improving a classic Brooks-Corey relative permeability model and a capillary pressure model used for numerical calculation in a solver of multi-phase flow in porous medium: obtaining a relation L=f₁(α) between liquid film thickness on rock surface and contact angle by a molecular simulation method, deducing a quantitative relation Kᵣ=f₃(S_{wr})=f₃(α) between a relative permeability Kᵣ and the contact angle α as well as a quantization relation P_{c}=f₄ (S_{wr})=f₄(α) between a capillary pressure P_{c} and the contact angle α in combination with a reservoir liquid residual saturation S_{wr}=f₂(L)=f₂(α), using the quantization relations as new relative permeability model and capillary pressure model to conduct simulation and calculation and quantitatively research the influence of contact angle on carbon dioxide seepage characteristics.

1.3) Using the improved solver of multi-phase flow in porous medium to conduct numerical calculation again, and conducting simulation for multiple times respectively in combination with a reservoir wettability optimization design scheme of step 2 to obtain the simulation results of carbon dioxide seepage characteristics in different contact angle conditions.

### Step 2, Reservoir Wettability Optimization Design Scheme:

According to the carbon dioxide sequestration process seepage characteristics simulation scheme, using the improved solver of multi-phase flow in porous medium to simulate the carbon dioxide seepage characteristics of the reservoir in different contact angle conditions, and conducting reservoir wettability optimization design according to the simulation results. The design scheme @(regulating the contact angle of the reservoir by two layers) is used to illustrate the embodiment.

As two high density fluids, i.e., water and oil, are mainly present in the reservoir of an oil field in addition to the rock and the injected carbon dioxide, two regulation schemes can be designed for the first regulation layer (41), i.e., the contact angles of water and oil are regulated respectively, and only the contact angle of the main displacing fluid oil is regulated in the second regulation layer (42). The embodiment is illustrated by taking the example of regulating the water contact angle by the first regulation layer (41), and regulating the oil contact angle by the second regulation layer (42):

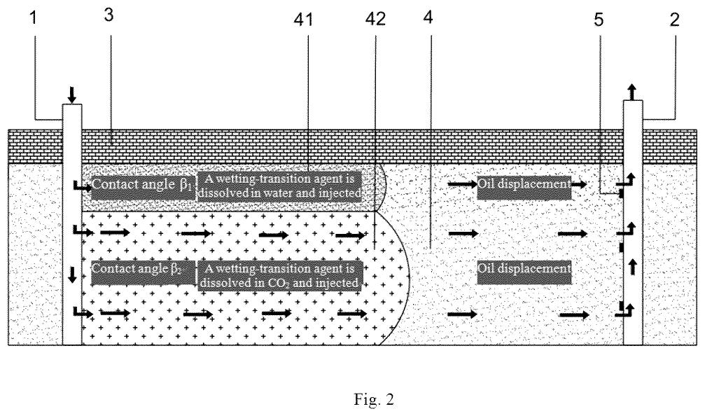

As shown in FIG. 2, a two-layer structure is designed for the reservoir (4) below the cover (3), comprising a first regulation layer (41) and a second regulation layer (42) below. In the case of designing into two layers, designing a smaller water contact angle β₁<115° below the cover (3), i.e., in the first regulation layer (41), and designing the height thereof into H₁<200 m, so that the hydrophilicity of the first regulation layer (41) is enhanced to prevent the diffusion of carbon dioxide hitherward, thus reducing the risk of carbon dioxide leakage near the cover (3) and enhancing the sealing property of the cover (3); designing a larger oil contact angle β₂>20° below the first regulation layer (41), i.e., in the second regulation layer (42), and designing the height thereof into 200-H₁, so that the wettability of the second regulation layer (42) is reduced and the second regulation layer (42) is used as a carbon dioxide sequestration layer; setting the value range of β₁ to [0°-30° ], [30°-60° ], [60°-90° ] and [90°-115° ], and the value range of β₂ to [20°-40° ], [40°-60° ], [60°-80° ], [80°-100° ], [100°-120° ] and [120°-140° ]; selecting 3 values at equal intervals for each range, and selecting 10 values of H₁ at equal intervals within the range of [0-100 m]; substituting different values of β₁, β₂ and H₁ respectively into the simulator for simulation; selecting the optimal value range of the water contact value β₁ as [10°-30° ], the value range of the oil contact value β₂ as [800-100° ], and H₁=30 m according to the simulation results; in this case, the capacity of carbon dioxide sequestration is the highest, the quantity of carbon dioxide leakage is the least, and the oil displacement efficiency is relatively high in the simulation results.

### Step 3, Reservoir Wettability Regulation Scheme:

When the design scheme \textcircled{2} is selected as the reservoir wettability optimization scheme, selecting the regulation scheme \textcircled{2} accordingly as the reservoir wettability regulation scheme. Selecting the optimal value range of the water contact value β₁ as [0°-30° ], the value range of the oil contact value β₂ as [80°-100° ], and H₁=30 m according to the simulation results in the reservoir wettability optimization design scheme. The corresponding regulation scheme is specifically as follows:

To achieve the value range [0°-30° ] of the water contact angle β₁ designed for the first regulation layer (41) in the design scheme \textcircled{2}, selecting a nonionic surfactant branched nonylphenol ethoxylate Indorama SURFONIC N-100 with a concentration of 0.1 wt %; and to achieve the value range [80°-100° ] of the oil contact angle β² designed for the second regulation layer (42), selecting a nonionic surfactant branched tridecyl ethoxylate Indorama SURFONIC TDA-9 with a concentration of 0.1 wt %.

Finally, injecting the selected wetting-transition agent into the corresponding regulation layers, and regulating the wettability of different regulation layers accordingly.

Further, selecting the injection mode CD as the wetting-transition agent injection mode:

When carbon dioxide is sequestrated, the N-100 wetting-transition agent is dissolved in water and injected into the first regulation layer (41), the TDA-9 wetting-transition agent is dissolved in the carbon dioxide to be sequestrated and injected into the second regulation layer (42), and the concentrations of the two wetting-transition agents are both 0.1 wt %;

Further, a carbon dioxide tracer perfluoro-1,2-dimethylcyclohexane is also injected simultaneously during carbon dioxide and wetting-transition agent injection to track the movement status of carbon dioxide in real time, and the concentration of the carbon dioxide tracer is L/4e7gCO₂.

In addition, the embodiment also provides a carbon dioxide sequestration well layout scheme:

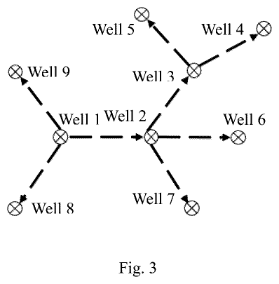

As shown in FIG. 3, in the embodiment, well 1 and well 2 are arranged first and used in conjunction, well 1 is used as an injection well (1) to inject carbon dioxide into the reservoir, and well 2 is used as a producing well (2).

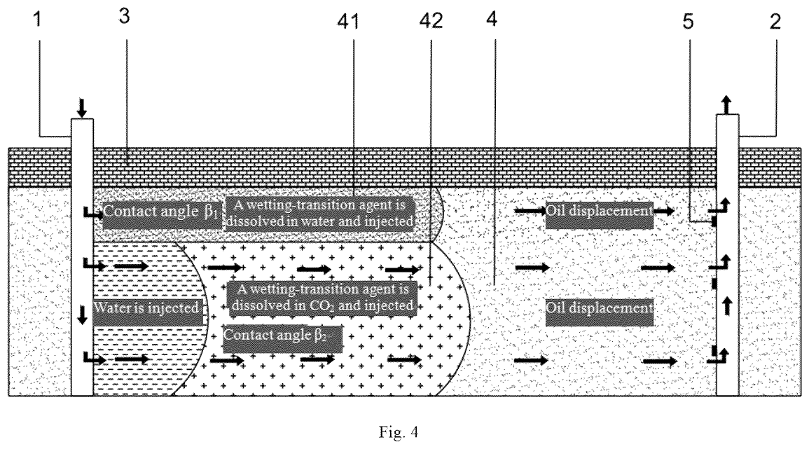

As shown in FIG. 4, the original oil and water in the reservoir are extracted while the carbon dioxide is injected, so as to reduce the injection pressure drag of the carbon dioxide and improve the injectability of the carbon dioxide. After carbon dioxide is injected by well 1 for a period of time, an appropriate amount of water can be injected to push the carbon dioxide to move forward, and then carbon dioxide injection can be continued for sequestration. The carbon dioxide monitoring point (5) is arranged in well 2 to monitor the concentration of ambient carbon dioxide in real time while the original fluids are extracted; when the concentration of carbon dioxide monitored by the carbon dioxide monitoring point (5) of well 2 reach a certain value, a certain amount of carbon dioxide is sequestrated in the reservoir between the two wells, and well 1 can be stopped.

As shown in FIG. 3, after well 1 is stopped, well 2 is used as an injection well (1) for injection, and well 3 is used as a producing well (2) for extraction and monitoring; by analogy, as shown in FIG. 3, well 3 & well 4, well 3 & well 5, well 2 & well 6, well 2 & well 7, well 1 & well 8, and well 1 & well 9 can be arranged for sequestration; and the distance and azimuth angles between the wells can be arranged as required to form a network layout.

The above embodiment only expresses the implementation of the present invention, and shall not be interpreted as a limitation to the scope of the patent for the present invention. It should be noted that, for those skilled in the art, several variations and improvements can also be made without departing from the concept of the present invention, all of which belong to the protection scope of the present invention.

1. A carbon dioxide sequestration method based on reservoir wettability optimization design and layered regulation, wherein the carbon dioxide sequestration method comprises the following four steps for a carbon dioxide sequestration process:
step 1, carbon dioxide sequestration process seepage characteristics simulation scheme:
1.1) detecting strata used for carbon dioxide sequestration and sampling a rock core to obtain a height H and an initial contact angle α₀ of a reservoir in the strata:
1.2) improving a relative permeability model and a capillary pressure model used for numerical calculation in a large scale simulator of carbon dioxide geological sequestration, conducting simulation and calculation by the improved relative permeability model and capillary pressure model, and quantitatively researching the influence of contact angle on carbon dioxide seepage characteristics:
1.3) using the large scale simulator of carbon dioxide geological sequestration improved in step 1.2) to conduct numerical calculation again, and conducting simulation for multiple times respectively in combination with a reservoir wettability optimization design scheme of step 2 to obtain the simulation results of carbon dioxide seepage characteristics in different contact angle conditions:
step 2, reservoir wettability optimization design scheme:
to increase the capacity of carbon dioxide sequestration and reduce the risk of carbon dioxide leakage, according to the carbon dioxide sequestration process seepage characteristics simulation scheme, using the large scale simulator improved in step 1.2) to simulate the carbon dioxide seepage characteristics of the reservoir in different contact angle conditions, and conducting reservoir wettability optimization design according to the simulation results: the design scheme comprises:
design scheme \textcircled{1}: conducting uniform design to the contact angle of the reservoir
designing the contact angle of the reservoir into a uniform and fixed value α>α₀, and setting different value ranges of α in the large scale simulator for simulation respectively: selecting an optimal value range of the contact angle α of the reservoir according to the simulation results, using the optimal value range as a target contact angle value range, and implementing a reservoir wettability regulation scheme according to the value range of a and the value of H;
design scheme \textcircled{2}: regulating the contact angle of the reservoir by two layers
designing a two-layer structure for the reservoir below a cover, comprising a first regulation layer and a second regulation layer below: designing a relatively small contact angle β₁<α₀ below the cover, i.e., in the first regulation layer, and designing the height thereof into H₁, wherein H₁<H, so that the wettability of the first regulation layer is enhanced to prevent the diffusion of carbon dioxide hitherward, thus reducing the risk of carbon dioxide leakage near the cover and enhancing the sealing property of the cover: designing a relatively large contact angle β₂>α₀ below the first regulation layer, i.e., in the second regulation layer, and designing the height thereof into H-H₁, so that the wettability of the second regulation layer is reduced and the second regulation layer is used as a carbon dioxide sequestration layer: setting different value ranges of β₁ and β₂ in the large scale simulator, matching with different values of H₁ for simulation respectively, selecting a set of optimal matches between the value ranges of β₁ and β₂ and the values of H₁ according to the simulation results, using the optimal value ranges as target contact angle value ranges, and implementing a reservoir wettability regulation scheme according to the value ranges of β₁ and β₂ and the values of H₁;
obtaining the heights and the target contact angle value ranges of the regulation layers through the above design scheme \textcircled{1} and design scheme \textcircled{2};
step 3, reservoir wettability regulation scheme:
selecting an appropriate wetting-transition agent according to the target contact angle value ranges set in the reservoir wettability optimization design scheme of step 2, and adopting different regulation schemes according to the different design schemes in step 2, which are specifically as follows:
regulation scheme \textcircled{1}: to achieve the uniform value range of the contact angle α set in the design scheme \textcircled{1}, selecting a wetting-transition agent of corresponding type and concentration, so that the wettability of rock can be effectively regulated by the wetting-transition agent to regulate the contact angle of the reservoir to the selected optimal value range of α;
regulation scheme \textcircled{2}: to achieve the value range of the contact angle β₁ designed for the first regulation layer and the value range of the contact angle β₂ designed for the second regulation layer in the design scheme \textcircled{2}, selecting a wetting-transition agent of corresponding type and concentration respectively to regulate the contact angles of the first regulation layer and the second regulation layer to the selected optimal value ranges of β₁ and β₂;
injecting the selected wetting-transition agent respectively into the regulation layers with the set heights according to the design schemes and the regulation schemes, and regulating the wettability of the regulation layers with different heights accordingly;
to prevent carbon dioxide leakage, injecting carbon dioxide at the bottom of the reservoir only.

2. The carbon dioxide sequestration method based on reservoir wettability optimization design and layered regulation according to claim 1, wherein the improvement in step 1.2) comprises the following specific steps: obtaining a relation L=f₁(α) between liquid film thickness on rock surface and contact angle by a molecular simulation method, deducing a quantitative relation Kᵣ=f₃(S_{wr})=f₃(α) between a relative permeability Kᵣ and the contact angle α as well as a quantization relation P_{c}=f₄(S_{wr})=f₄(α) between a capillary pressure P_{c} and the contact angle α in combination with a reservoir liquid residual saturation S_{wr}=f₂(L)=f₂(α), and using the quantization relations as the improved relative permeability model and capillary pressure model.

3. The carbon dioxide sequestration method based on reservoir wettability optimization design and layered regulation according to claim 1, wherein in the design scheme \textcircled{1}, a criterion for judging an optimal match between the value range of the contact angle and the value of the height of the regulation layer is that, within a certain injection time and sequestration time, the higher the capacity of carbon dioxide sequestration and the lower the quantity of leakage are, the better the match between the contact angle and the height of a regulation layer is; and in the design scheme \textcircled{2}, a criterion for judging an optimal match between the value ranges of β₁ and β₂ and the value of H₁ is that, within a certain injection time and sequestration time, the higher the capacity of carbon dioxide sequestration and the lower the quantity of leakage are, the better the match between the contact angles and the height of a regulation layer is.

4. The carbon dioxide sequestration method based on reservoir wettability optimization design and layered regulation according to claim 1, wherein when more than one high density fluids are present in the reservoir, the contact angle of a main displacing fluid in the reservoir is regulated uniformly in the design scheme \textcircled{1}; and in the design scheme \textcircled{2}, two regulation schemes can be designed for the first regulation layer, i.e., the contact angles of two fluids are regulated respectively, and only the contact angle of the main displacing fluid is regulated in the second regulation layer.

5. The carbon dioxide sequestration method based on reservoir wettability optimization design and layered regulation according to claim 1, wherein the wetting-transition agent injection modes for the design scheme \textcircled{1} and the regulation scheme \textcircled{1} include:
injection mode \textcircled{1}: when carbon dioxide is sequestrated, a corresponding wetting-transition agent is dissolved in the carbon dioxide to be sequestrated and injected into the reservoir together;
injection mode \textcircled{2}: a corresponding wetting-transition agent is dissolved in water and injected into the reservoir in advance, and after a period of time, carbon dioxide is injected into the reservoir for sequestration.

6. The carbon dioxide sequestration method based on reservoir wettability optimization design and layered regulation according to claim 1, wherein the wetting-transition agent injection modes for the design scheme \textcircled{2} and the regulation scheme \textcircled{2} include:
injection mode \textcircled{1}: when carbon dioxide is sequestrated, a corresponding wetting-transition agent is dissolved in water and injected into the first regulation layer, and the corresponding wetting-transition agent is dissolved in the carbon dioxide to be sequestrated and injected into the second regulation layer together;
injection mode \textcircled{2}: a corresponding wetting-transition agent is dissolved in water and injected into corresponding regulation layers in advance, and after a period of time, carbon dioxide is injected into the second regulation layer for sequestration.

7. The carbon dioxide sequestration method based on reservoir wettability optimization design and layered regulation according to claim 1, wherein a carbon dioxide tracer can also be injected simultaneously during carbon dioxide and wetting-transition agent injection to track the movement status of carbon dioxide in real time.

8. The carbon dioxide sequestration method based on reservoir wettability optimization design and layered regulation according to claim 1, wherein after the reservoir wettability regulation scheme is implemented, a carbon dioxide sequestration well layout scheme can also be designed, which uses a well layout mode of “using one well for multiple purposes—using two wells in conjunction—adopting a network layout”.

9. The carbon dioxide sequestration method based on reservoir wettability optimization design and layered regulation according to claim 8, wherein:
using one well for multiple purposes means that one well can be used as either an injection well or a producing well, and is provided with a carbon dioxide monitoring point which can monitor the concentration of carbon dioxide in real time;
using two wells in conjunction means that well 1 and well 2 are used in conjunction in a carbon dioxide sequestration process, well 1 is used as an injection well to inject carbon dioxide into the reservoir, and well 2 is used as a producing well to extract the original fluid in the reservoir while the carbon dioxide is injected, so as to reduce the injection pressure drag of the carbon dioxide and improve the injectability of the carbon dioxide: after carbon dioxide is injected by well 1 for reaction, an appropriate amount of water can be injected to push the carbon dioxide to move forward, and then carbon dioxide injection is continued for sequestration: the concentration of ambient carbon dioxide is monitored by well 2 in real time while the original fluid is extracted;
adopting a network layout means that: well 1 and well 2 are arranged first, well 1 is used as an injection well, and well 2 is used as a producing well: when the concentration of carbon dioxide monitored by well 2 reach a certain value, carbon dioxide is sequestrated in the reservoir between the two wells, and well 1 can be stopped: well 2 is used as an injection well for injection, and well 3 is used as a producing well for extraction and monitoring: by analogy, after sequestration is completed by well 2 and well 3, well 4, well 5 and well 6 can be further arranged for sequestration; and the distance and azimuth angles between the wells can be arranged as required to form a network layout.
